(19) United States
(12) Patent Application Publication
(10) Pub. No.: US 2007/0213054 A1
(43) Pub. Date: Sep. 13, 2007

(54) Method and system for providing billing information of wireless data communication service

(75) Inventor: Seung-Wook Han, Seongnam-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/712,220

(22) Filed: Feb. 28, 2007

(30) Foreign Application Priority Data
Feb. 28, 2006 (KR) P2006-19658

(51) Int. Cl. H04Q 7/20

(52) U.S. Cl. 455/435.2

(57) ABSTRACT

A system for providing billing information of a wireless data communication service includes an Inter-Working function (IWF) for, if a data call is received, assigning an Internet protocol (IP) address to a mobile communication terminal that has sent the data call and transmitting the assigned IP address to a billing server; the billing server for, if the IP address is received, searching for billing information related to the mobile communication terminal from among stored billing information, inserting the found billing information into a ping message, and transmitting the ping message to the mobile communication terminal; and the mobile communication terminal for sending the data call, receiving the assigned IP address, performing wireless data communication using the assigned IP, transmitting a ping response message to the billing server if a ping message is received from the billing server, determining whether the ping message contains billing information, and displaying the billing information contained in the ping message if it is determined that the ping message contains billing information.

### PRIORITY

This application claims priority under 35 U.S.C. § 119 to an application entitled “Method and System for Providing Billing Information of Wireless Data Communication Service” filed in the Korean Intellectual Property Office on February 28, 2006 and assigned Serial No. 2006-19658, the contents of which are incorporated herein by reference.

### BACKGROUND OF THE INVENTION

1. Field of the Invention

The present invention relates generally to a wireless data communication service, and in particular, to a method and system for transmitting billing information of a wireless data communication service.

2. Description of the Related Art

Accompanying the development of mobile communication, wireless data communication for transmitting and receiving voice data and non-voice data in a wireless communication method is available on the market, and various types of wireless data communication services related to the wireless data communication are provided. A representative type of the wireless data communication services is a wireless Internet service. In general, while a fee is determined according to a usage time in voice communication, a fee of a wireless data communication service, such as a wireless Internet service, is divided into a communication fee and an information fee. The communication fee is billed in proportion to a usage time of the wireless data communication service or the number of packets used for wireless data communication, and the information fee is billed according to a type of information downloaded through a mobile communication terminal. However, a system provides billing information of the information fee in realtime when information is downloaded so that a user can clearly check the information fee but does not provide billing information of the communication fee in realtime.

In general, the communication fee of the wireless data communication service is billed according to a total number of used packets, however, a usage bill of a predetermined unit packet is set differently according to a type of information transmitted or received through wireless data communication. At the present time, an information type is classified into text information, multimedia information, and moving picture information, and the size of a billing unit packet is set to 512 bytes. An information type in a wireless Internet service includes text information, which is character format information, and the wireless Internet service is realized using a handheld device markup language (HDML) and a wireless markup language (WML) as basic languages. The information types also include multimedia information, which is a wireless Internet service provided through the Java virtual machine after combining more than two media among voice, pictures, text, and data, and moving picture information, which is a wireless Internet service provided using a certain compression scheme, such as Moving Picture Experts Group 4 (MPEG4) for video on demand/music on demand (VOD/MOD), after combining more than two media among voice, pictures, text, and data.

The billing fee of a wireless Internet service on the market differs according to mobile communication providers and is also very different according to pricing plans selected by users. Thus, a user can guess a billed wireless data communication fee only if the user understands a billing system of a wireless data communication service according to a selected pricing plan. However, it is inconvenient for a user to entirely understand a complicated billing system, and even though the user understands the complicated billing system, the user cannot calculate a correct price for every wireless data communication. Moreover, it is more difficult to calculate an accumulated fee.

Even though a mobile communication system commonly provides a service of transmitting a total number of packets used in a wireless data communication service to a user immediately after the wireless data communication service is finished or transmitting billing information to the user if a wireless data communication fee is accumulated over a predetermined sum of money, the user cannot obtain correct billing information through the service due to the above-described reasons. In addition, a method of checking billing information in realtime during a wireless data communication service does not exist.

### SUMMARY OF THE INVENTION

To substantially solve at least the above problems and/or disadvantages and to provide at least the advantages below, the present invention provides a method and system for conveniently transmitting billing information according to wireless data communication to a user.

The present invention provides a method and system for transmitting correct billing information according to wireless data communication to a user.

The present invention provides a method and system for transmitting billing information to a user in realtime during wireless data communication.

According to one aspect of the present invention, there is provided a method of providing billing information of a wireless data communication service in a mobile communication terminal, the method including sending a data call; receiving an assigned Internet protocol (IP) address and performing wireless data communication using the assigned IP; if a ping message is received from a billing server, transmitting a ping response message to the billing server; and determining whether the ping message contains billing information and displaying the billing information contained in the ping message if it is determined that the ping message contains billing information.

According to another aspect of the present invention, there is provided a method of providing billing information of a wireless data communication service in a billing server, the method including receiving an Internet protocol (IP) address assigned to a certain mobile communication terminal; and searching for billing information related to the certain mobile communication terminal from among stored billing information, inserting the found billing information into a ping message, and transmitting the ping message to the certain mobile communication terminal.

According to another aspect of the present invention, there is provided a system for providing billing information of a wireless data communication service, including an Inter-Working function (IWF) for, if a data call is received, assigning an Internet protocol (IP) address to a mobile communication terminal that has sent the data call and transmitting the assigned IP address to a billing server; the billing server for, if the IP address is received, searching for billing information related to the mobile communication terminal from among stored billing information, inserting the found billing information into a ping message, and transmitting the ping message to the mobile communication terminal; and the mobile communication terminal for sending the data call, receiving the assigned IP address, performing wireless data communication using the assigned IP address, transmitting a ping response message to the billing server if the ping message is received from the billing server, determining whether the ping message contains billing information, and displaying the billing information contained in the ping message if it is determined that the ping message contains billing information.

### BRIEF DESCRIPTION OF THE DRAWINGS

The above and other objects, features and advantages of the present invention will become more apparent from the following detailed description when taken in conjunction with the accompanying drawing in which:

FIG. 1 illustrates a configuration of a mobile communication system according to the present invention;

FIG. 2 is a block diagram of a mobile communication terminal according to the present invention;

FIG. 3 is a signaling diagram of explaining a message flow according to the present invention; and

FIG. 4 illustrates a data structure of a ping message according to the present invention.

### DETAILED DESCRIPTION OF THE PREFERRED EMBODIMENT

Preferred embodiments of the present invention will be described herein below with reference to the accompanying drawings. In the drawings, the same or similar elements are denoted by the same reference numerals even though they are depicted in different drawings. In the following description, well-known functions or constructions are not described in detail since they would obscure the invention in unnecessary detail.

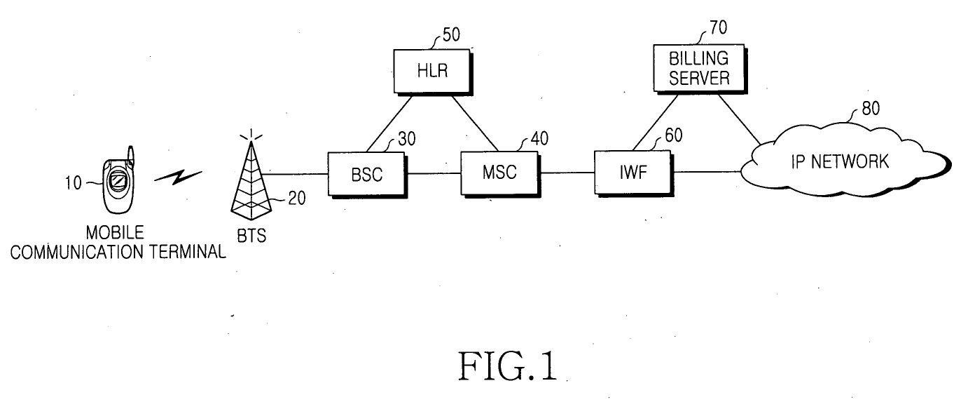

FIG. 1 illustrates a configuration of a mobile communication system according to the present invention. Referring to FIG. 1, the mobile communication system includes a mobile communication terminal 10, a base transceiver station (BTS) 20, a base station controller (BSC) 30, a mobile switching center (MSC) 40, a home location register (HLR) 50, an Inter-Working Function (IWF) 60, a billing server 70, and an Internet protocol (IP) network 80.

The BTS 20 performs communication with the mobile communication terminal 10 using a Radio Frequency (RF) channel, controls a wireless link and a wired link under a control of the BSC 30, and performs a handoff function to maintain continuity of a call even while a subscriber is moving.

The HLR 50 is a middle-class computer mainly performing a function of managing mobile communication terminal subscribers, storing subscriber information and position information of mobile communication terminals, and routing an incoming call.

The MSC 40 inquires about a subscriber to the HLR 50 when the mobile communication terminal 10 requests to send or receive a voice call and processes the voice call by interworking with another MSC if necessary. In addition, in order to process a data call sending request of the mobile communication terminal 10, the MSC 40 transmits the data call sending request to the IWF 60 with subscriber data received from the HLR 50. The MSC 40 receives an assigned IP address from the IWF 60, transmits the assigned IP address to the mobile communication terminal 10, and provides a wireless data communication service to the mobile communication terminal 10 by connecting the mobile communication terminal 10 to the IP network 80 via the IWF 60.

The IWF 60 is a network interworking device for interworking a mobile communication network and the IP network 80. The IWF 60 assigns an IP address in response to a data call sending request of the mobile communication terminal 10 received via the MSC 40 and transmits the assigned IP address to the mobile communication terminal 10 via the MSC 40, the BSC 30, and the BTS 20. The IWF 60 also transmits the assigned IP address with identification information of the mobile communication terminal 10 to the billing server 70.

The billing server 70 is connected to the IWF 60 and the IP network 80, bills each mobile communication terminal for the terminal's wireless data communication service, and stores billing information of the mobile communication terminals. According to the present invention, if the billing server 70 receives identification information of a certain mobile communication terminal and an IP address assigned to the certain mobile communication terminal, the billing server 70 searches for accumulated billing information of the certain mobile communication terminal. The billing server 70 inserts the found billing information into a ping message and transmits the ping message to the certain mobile communication terminal. If a billing information request ping message is received from the mobile communication terminal 10, the billing server 70 searches for billing information requested through the billing information request ping message, creates a billing ping message, and transmits the billing ping message to the mobile communication terminal 10.

The ping, one of UNIX instructions, is an instruction for determining accessibility of a communication device corresponding to an assigned IP address, and is used to determine whether a target device operates or whether the target device is connected to a communication network. An Internet control message protocol (ICMP) is used as a communication protocol. In general, when a wireless data communication service is provided to a certain mobile communication terminal in the mobile communication system, in order to confirm a normal connection of the certain mobile communication terminal, after the IWF 60 assigns an IP address to the certain mobile communication terminal, the billing server 70 transmits a ping message to the certain mobile communication terminal using the assigned IP address. If a ping response message is received from that mobile communication terminal, the billing server 70 determines that the mobile communication terminal is normally connected to the mobile communication system. Herein, the ping message includes a data field containing invalid data. According to the present invention, a format of the data field is newly defined, and a billing ping message is configured by inserting billing information into the newly defined data field. Since the ping is already reflected on the mobile communication system and belongs to a data protocol, a ping message can be transmitted or received without allocating additional resources and directly interworked with a user application of a mobile communication terminal without passing through other layers. Thus, even though a mobile communication terminal is performing a certain application according to a wireless data communication service, the mobile communication terminal can inquire about billing information in realtime without stopping the application being performed or beginning a new application.

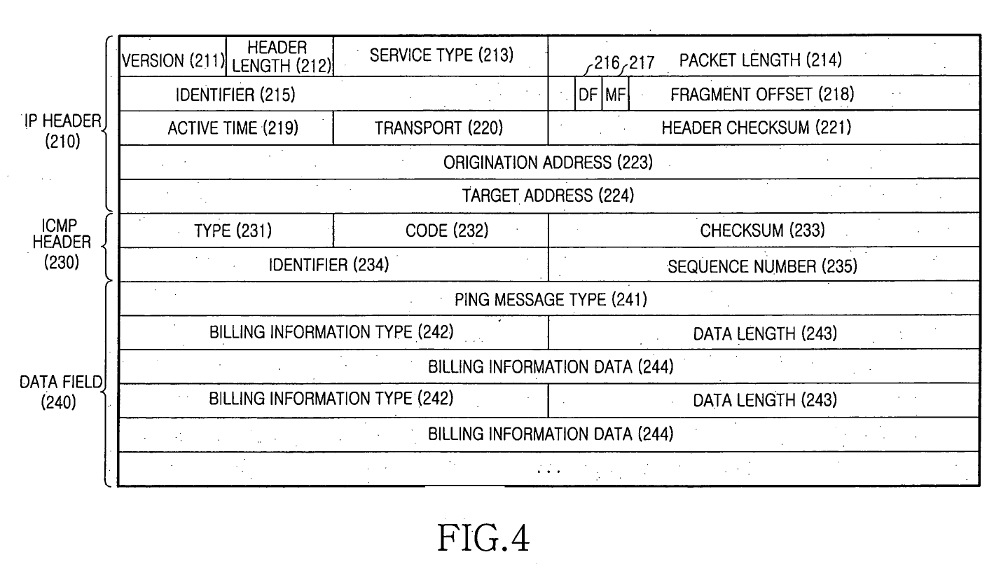

FIG. 4 illustrates a data structure of a ping message according to the present invention. As illustrated in FIG. 4, the ping message includes an IP header 210, an ICMP header 230, and a data field 240.

The IP header 210 includes a version field 211 in which version information is stored, a header length field 212 in which header length information is stored, a service type field 213 in which service type information is stored, and a packet length field 214 in which total packet length information is stored. The IP header 210 also includes an identifier field 215 in which identifier information is stored, a “Do not Fragment” (DF) field 216, a “Make Fragment” (MF) field 217, and a fragment offset When the size of billing information related to a single mobile communication terminal is too large to contain all information in a single billing ping message, a plurality of billing ping messages linked to each other are created, and in this case, the DF field 216, the MF field 217, and the fragment offset field 218 are message fields in which information on the plurality of billing ping messages are stored. The IP header 210 also includes an active time field 219, a transport field 220, a header checksum field 221, a origination address field 223 in which message sender address information is stored, and a target address field 224 in which message target address information is stored. When the mobile communication terminal 10 initially receives a ping message from the billing server 70, the mobile communication terminal 10 can obtain an address of the billing server 70 by checking the origination address field 223.

The ICMP header 230 includes a type field 231, a code field 232, a checksum field 233, an identifier field 234, and a sequence number field 235, and stores general information related to the ICMP.

The data field 240 includes a ping message type field 241, a billing information type field 242, a data length field 243, and a billing information data field 244. The ping message type field 241 is a field in which identification information for identifying whether the ping message is a general ping message for checking a connection state of a certain device or a billing ping message containing billing information is stored, and according to the present invention, an IP address of a mobile communication terminal related to the billing information is used as the identification information. In other words, if data included in the ping message type field 241 matches data included in the origination address field 223 or the target address field 224 of the IP header 210, the ping message is a billing ping message. The billing information data field 244 is a field in which billing data is stored, and the billing information type field 242 is a field in which a billing code indicating a type of the billing data stored in the billing information data field 244 is stored. Billing codes used in the billing ping message are illustrated in Table 1.

TABLE 1

| Billing | |
|---|---|
| code | Information type |
| 0x01 | Information on currently used article |
| 0x02 | Current information fee after connection |
| 0x03 | Monthly accumulated information fee to be paid |
| 0x04 | Current communication fee after connection |
| 0x05 | Monthly accumulated communication fee to be paid |
| 0x06 | Monthly sum of information fee and communication fee |
| | to be paid |

One of the billing codes illustrated in Table 1 is stored in the billing information type field 242, and billing data corresponding to the billing code stored in the billing information type field 242 is stored in the billing information data field 244. The number of billing information type fields 242, data length fields 243, and billing information data fields 244 corresponds to the number of types of billing information.

If the ping message illustrated in FIG. 4 is transmitted as a general ping message, invalid data or no data is stored in the ping message type field 241, the billing information type field 242, and the billing information data field 244. If the ping message illustrated in FIG. 4 is transmitted as a billing ping message, an IP address of a mobile communication terminal related to billing information stored in the ping message is stored in the ping message type field 241. The billing ping message in which a billing code and billing data corresponding to the billing code are respectively stored in the billing information type field 242 and the billing information data field 244 can be identified as a billing information ping message and is mainly used in order for the billing server 70 to transmit billing information to the mobile communication terminal 10. A billing information ping message in which valid data is stored only in the billing information type field 242 can be identified as a billing information request message and is mainly used in order for the mobile communication terminal 10 to transmit a specific billing information request to the billing server 70.

Referring back to FIG. 1, the mobile communication terminal 10 performs wireless communication with the BTS 20 using an RF channel. According to the present invention, the mobile communication terminal 10 sends a data call in response to a user's request, and if a general ping message or a billing ping message is received from the billing server 70, the mobile communication terminal 10 transmits a ping response message to the billing server 70. In addition, the mobile communication terminal 10 provides billing information included in the received billing ping message to a user, creates a billing information request ping message for requesting for specific billing information during wireless data communication in response to a user's request, and transmits the created billing information request ping message to the billing server 70 through the mobile communication system.

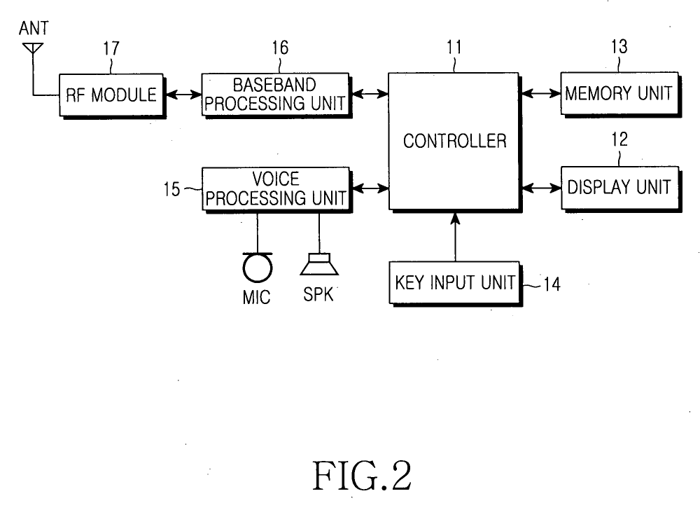

FIG. 2 is a block diagram of the mobile communication terminal 10 according to the present invention. Referring to FIG. 2, the mobile communication terminal 10 includes a controller 11, a display unit 12, a memory unit 13, a key input unit 14, a voice processing unit 15, a baseband processing unit 16, and an RF module 17.

The controller 11 controls a general operation of the mobile communication terminal 10. The controller 11 controls the display unit 12 to display various kinds of image information and an image received from the BTS 20 or stored in the memory unit 13 on a screen. The key input unit 14 includes a * key, a # key, and various function keys, such as menu, select, send, cancel, power/end, volume, and capture keys corresponding to various functions performed by the mobile communication terminal 10 and provides key input data corresponding to a key pressed by the user to the controller 11. The key input unit 14 also includes character keys to which numerals 0 to 9 and a plurality of letters are allocated. The RF module 17 transmits/receives an RF signal to/from the BTS 20 via an antenna ANT. In detail, the RF module 17 modulates a signal to be transmitted, which is input from the controller 11 via the baseband processing unit 16 to an RF signal and sends the RF signal via the antenna ANT, and demodulates an RF signal input via the antenna ANT and outputs the demodulated signal to the controller 11 via the baseband processing unit 16. The baseband processing unit 16 processes a baseband signal communicated between the RF module 17 and the controller 11. The voice processing unit 15 is connected to the controller 11 and a microphone MIC and a speaker SPK connected to the voice processing unit 15 to make a phone call or record voice. The memory unit 13 stores programs for processing and controlling of the controller 11, reference data, and various kinds of updatable storage data and is provided as a working memory of the controller 11. According to the present invention, the memory unit 13 stores a ping message format, the billing codes illustrated in FIG. 4, and program data related to a billing request menu.

The mobile communication terminal 10 sends a data call in response to a user's request. The mobile communication terminal 10 also receives an assigned IP address from the IWF 60 and receives a ping message from the billing server 70. The controller 11 of the mobile communication terminal 10 transmits a ping response message to the billing server 70 and performs wireless data communication using the assigned IP address. The controller 11 determines whether the assigned IP address is included in the ping message type field 241 of the received ping message, and if it is determined that the assigned IP address is included in the ping message type field 241 of the received ping message, the controller 11 determines that the received ping message is a billing ping message. If it is determined that the assigned IP address is not included in the ping message type field 241 of the received ping message, the controller 11 determines that the received ping message is a general ping message. The controller extracts billing information included in the received billing ping message and provides the extracted billing information to the user in a text form. Herein, even though the mobile communication terminal 10 is executing a certain wireless data communication service application, the mobile communication terminal 10 can be set to display the billing information provided only in the text form during a predetermined time with maintaining the application being executed. In addition, the mobile communication terminal 10 can be set to stop displaying the billing information if a predetermined key is selected.

If the user inputs a specific billing information request while performing wireless data communication, the controller 11 creates a billing information request ping message to request the specific billing information and transmits the created billing information request ping message to the billing server 70 through the mobile communication system. The billing information request can be input by selecting a predetermined billing information request key or a billing information request menu. The billing information request key is previously set as a predetermined key among the plurality of keys included in the mobile communication terminal 10, and if the billing information request key is selected by the user during wireless data communication, the controller 11 creates a billing information request ping message and transmits the created billing information request ping message to the billing server 70 while maintaining a wireless data communication service. The billing information request ping message includes a billing code corresponding to the billing information desired by the user, and the billing code is included in a billing information request ping message previously set by the user or set immediately before the billing information request ping message is transmitted according to selection of a relevant menu during a wireless data communication service. The mobile communication terminal 10 provides billing information, which is included in a billing information ping message received in response to the billing information request ping message, to the user as described below.

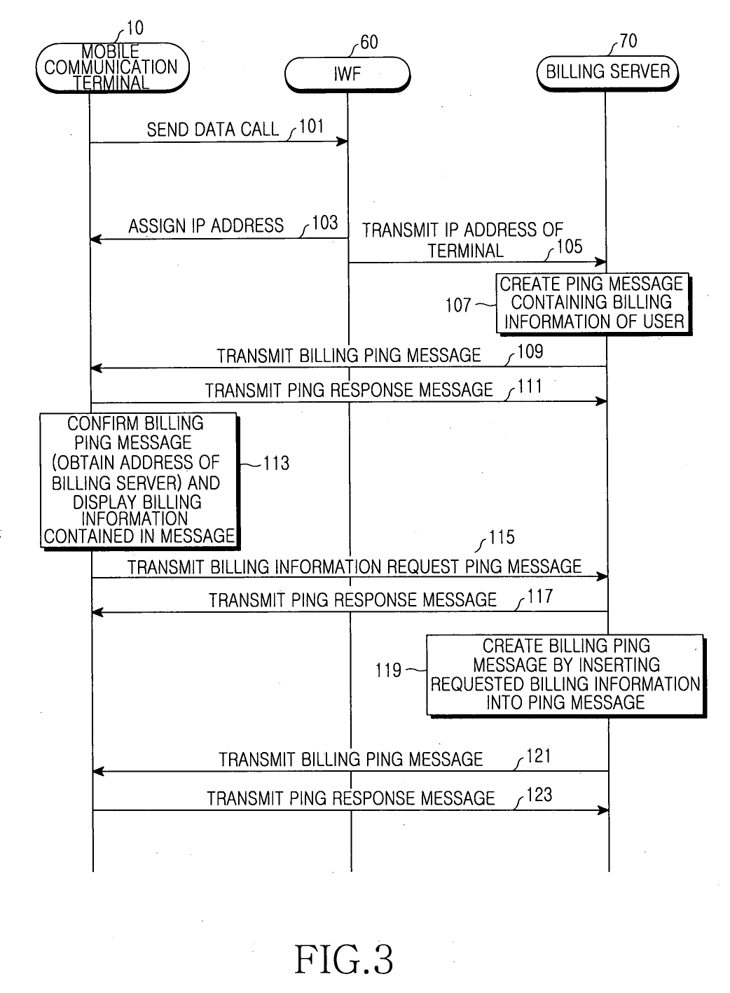

Operations of the mobile communication terminal 10, the IWF 60, and the billing server 70 included in the mobile communication system illustrated in FIG. 1 will now be described with reference to FIG. 3. FIG. 3 is a signaling diagram explaining a message flow according to the present invention.

Referring to FIG. 3, the mobile communication terminal 10 sends a data call in response to a user's request in step 101. The BTS 20, which has received the data call of the mobile communication terminal 10, informs the IWF 60 that the mobile communication terminal 10 has sent the data call by transmitting the data call to the MSC 40 via the BSC 30. The IWF 60 assigns an IP address to the mobile communication terminal 10 that has sent the data call and transmits the assigned IP address to the mobile communication terminal 10 via the MSC 40, the BSC 30, and the BTS 20 in step 103. The IWF 60 also transmits the IP address assigned to the mobile communication terminal 10 to the billing server 70 in step 105.

The billing server 70, which has received the IP address of the mobile communication terminal 10, searches for billing information of the user of the mobile communication terminal 10 and creates a billing ping message including the found billing information in step 107. The billing server 70 transmits the created billing ping message to the mobile communication terminal 10 via the MSC 40, the BSC 30, and the BTS 20 in step 109. The mobile communication terminal 10, which has received the ping message, transmits a ping response message to the billing server 70 in step 111. Herein, if the ping response message is not received from the mobile communication terminal 10 within a predetermined time, the billing server 70 retransmits the billing ping message a predetermined number of times. In step 113, the mobile communication terminal 10 determines, by checking the ping message type field 241 of the ping message received in step 111, that the received ping message is a billing ping message and displays the billing information included in the billing ping message. If the user inputs a specific billing information request, the mobile communication terminal 10 creates a billing information request ping message and transmits the created billing information request ping message to the billing server 70 in step 115. The billing server 70 transmits a ping response message to the mobile communication terminal 10 in step 117.

In step 119, if the billing server 70 determines by checking the origination address field 223 and the ping message type field 241 of the ping message received in step 115 that the received ping message is a billing information request ping message, detects a billing code included in the received billing information request ping message, the billing server 70 detects billing information corresponding to the detected billing code from among billing information of the user, and creates a billing ping message including the detected billing information. The billing server 70 transmits the created billing ping message to the mobile communication terminal 10 in step 121. The mobile communication terminal 10, which has received the billing ping message, transmits a ping response message to the billing server 70 and displays the billing information included in the received billing ping message in step 123.

As described above, according to the present invention, by inserting billing information generated according to a wireless data communication service performed by a mobile communication terminal into a ping message and sending the ping message, a user can easily check the billing information, and by requesting billing information using a ping message, the user can easily check the billing information even during a wireless data communication service.

While the invention has been shown and described with reference to a certain preferred embodiment thereof, it will be understood by those skilled in the art that various changes in form and details may be made therein without departing from the spirit and scope of the invention. For example, although the mobile communication system preferably uses the Code Division Multiple Access (CDMA) scheme, the invention can be applied to a mobile communication system using the Global System for Mobile communications (GSM) scheme. Thus, the spirit and scope of the invention is defined by the appended claims.

What is claimed is:

1. A method of providing billing information of a wireless data communication service in a mobile communication terminal, the method comprising the steps of:
sending a data call;
receiving an assigned Internet protocol (IP) address and performing wireless data communication using the assigned IP address;
if a ping message is received from a billing server, transmitting a ping response message to the billing server; and
determining whether the ping message contains billing information and displaying the billing information contained in the ping message if it is determined that the ping message contains billing information.

2. The method of claim 1, further comprising, if a user inputs a specific billing information request, creating a ping message containing a billing code indicating a billing information type corresponding to the specific billing information and transmitting the created ping message to the billing server.

3. The method of claim 2, wherein the step of displaying the billing information contained in the ping message comprises:
comparing data contained in a ping message type field of a data field of the ping message to the assigned IP address; and
if the data contained in the ping message type field matches the assigned IP address, determining that the ping message contains billing information and displaying the billing information contained in the ping message in a text form.

4. A method of providing billing information of a wireless data communication service in a billing server, the method comprising the steps of:
receiving an Internet protocol (IP) address assigned to a certain mobile communication terminal; and
searching for billing information related to the certain mobile communication terminal from among stored billing information, inserting the found billing information into a ping message, and transmitting the ping message to the certain mobile communication terminal.

5. The method of claim 4, further comprising, if a ping response message is not received from the certain mobile communication terminal within a predetermined time, repeatedly transmitting the ping message a predetermined number of times.

6. The method of claim 5, further comprising:
receiving a billing information request ping message from the certain mobile communication terminal;
searching for billing information corresponding to a billing code indicating a billing information type, which is contained in the billing information request ping message;
creating a ping message containing the found billing information and transmitting the created ping message to the certain mobile communication terminal.

7. The method of claim 6, further comprising, when the billing information request ping message is received from the certain mobile communication terminal, comparing an origination address contained in an IP header of the received billing information request ping message to data contained in a ping message type field of a data field of the received billing information request ping message, and if the origination address contained in the IP header matches the data contained in the ping message type field, determining that the received ping message is a billing information request ping message.

8. The method of claim 7, further comprising, if the billing information request ping message is received from the certain mobile communication terminal, transmitting a response ping message to the certain mobile communication terminal.

9. A system for providing billing information of a wireless data communication service, the system comprising:
an Inter-Working function (IWF) for, if a data call is received, assigning an Internet protocol (IP) address to a mobile communication terminal that has sent the data call and transmitting the assigned IP address to a billing server;
the billing server for, if the IP address is received, searching for billing information related to the mobile communication terminal from among stored billing information, inserting the found billing information into a ping message, and transmitting the ping message to the mobile communication terminal; and
the mobile communication terminal for sending the data call, receiving the assigned IP address, performing wireless data communication using the assigned IP address, transmitting a ping response message to the billing server if the ping message is received from the billing server, determining whether the ping message contains billing information, and displaying the billing information contained in the ping message if it is determined that the ping message contains billing information.

10. The system of claim 9, wherein if a user inputs a specific billing information request, the mobile communication terminal creates a ping message containing a billing code indicating a billing information type corresponding to the specific billing information and transmits the created ping message to the billing server.

11. The system of claim 10, wherein when the billing information contained in the ping message is displayed, the mobile communication terminal compares data contained in a ping message type field of a data field of the ping message to the assigned IP address, and if the data contained in the ping message type field matches the assigned IP address, the mobile communication terminal determines that the ping message contains billing information and displays the billing information contained in the ping message in a text form.

12. The system of claim 11, wherein if a ping response message is not received from the mobile communication terminal within a predetermined time, the billing server repeatedly transmits the ping message a predetermined number of times.

13. The system of claim 12, wherein if the billing information request ping message is received from the mobile communication terminal, the billing server searches for billing information corresponding to a billing code indicating a billing information type, which is contained in the billing information request ping message, creates a ping message containing the found billing information, and transmits the created ping message to the mobile communication terminal.

14. The system of claim 13, wherein when the billing information request ping message is received from the mobile communication terminal, the billing server compares an origination address contained in an IP header of the received billing information request ping message to data contained in a ping message type field of a data field of the received billing information request ping message, and determines that the received ping message is a billing information request ping message if the origination address contained in the IP header matches the data contained in the ping message type field.

15. The system of claim 14, wherein if the billing information request ping message is received from the mobile communication terminal, the billing server transmits a response ping message to the mobile communication terminal.
